(19) United States
(12) Patent Application Publication
(10) Pub. No.: US 2016/0274450 A1
(43) Pub. Date: Sep. 22, 2016

(54) SCREEN AND DISPLAY/IMAGING DEVICE

(71) Applicant: SHARP KABUSHIKI KAISHA, Osaka-shi, Osaka (JP)

(72) Inventors: Naru USUKURA, Osaka (JP); Takafumi SHIMATANI, Osaka (JP)

(73) Assignee: Sharp Kabushiki Kaisha, Osaka (JP)

(21) Appl. No.: 15/033,839

(22) PCT Filed: Jul. 22, 2014
(86) PCT No.: PCT/JP2014/069304

§ 371 Date: May 2, 2016

(30) Foreign Application Priority Data
Nov. 5, 2013 (JP) 2013-229557

(51) Int. Cl. G03B 21/604; G02B 5/02; G02B 5/30

(52) U.S. Cl. CPC G03B 21/604; G02B 5/30; G02B 5/02

(57) ABSTRACT

The present invention improves the light usage efficiency of image light. A screen according to one configuration of the present invention includes: a polarized light scattering layer that scatters horizontally-polarized light; a polarizing layer that blocks horizontally-polarized light and transmits vertically-polarized light; and a reflective layer that is disposed between the polarized light scattering layer and the polarizing layer. The reflective layer reflects light in accordance with the wavelength or polarization direction thereof so as to selectively reflect horizontally-polarized image light to be projected onto the screen.

### TECHNICAL FIELD

The present invention relates to a screen and a display/imaging device.

### BACKGROUND ART

So-called “transparent screen” technology, in which a screen is transparent and displays images, has been well-known for some time. In addition, a method of imaging a viewer who is viewing the screen, or the like, by using a camera, a polarizing plate, and a transparent screen (polarized light scattering film) that has polarization selectivity is also already known as a form of conventional technology.

Patent Document 1 discloses a reflective display/imaging device in which a liquid crystal projector is disposed on the same side of the device as a subject (person) and in which a camera that includes a polarizing plate is disposed on a side of the device that faces the subject. Specifically, this display/imaging device displays images on a polarized light scattering plate via the liquid crystal projector disposed on the same side of the device as the subject. Furthermore, this display/imaging device images the subject via the camera, which is equipped with a polarizing plate and is disposed in a location that faces the subject with the polarized light scattering plate interposed therebetween.

Patent Document 2 discloses a method that, via polarization, distinguishes between image light and light for imaging via the camera.

### RELATED ART DOCUMENTS

### Patent Documents

Patent Document 1: Japanese Patent No. 3496871 (Published on Feb. 16, 2004)

Patent Document 2: Japanese Patent No. 2846120 (Published on Jan. 13, 1999)

### SUMMARY OF THE INVENTION

### Problems to be Solved by the Invention

However, there is a problem with the configurations disclosed in Patent Documents 1 and 2 in that the polarization selectivity for scattering polarized light that is possessed by the polarized light scattering plate is inadequate; thus, it is difficult to provide the polarized light scattering plate with adequate scattering properties. As a result, even if light from an image source is scattered via polarized light scattering, most of the light, while scattered, will still propagate toward the polarizing plate. Therefore, there will be a decrease in light usage efficiency.

An aim of the present invention is to provide a screen and imaging/display device that can improve the light usage efficiency of image light.

### Means for Solving the Problems

A screen according to one configuration of the present invention is a screen for reflecting projected image light of a first polarization direction, the screen including: a polarized light scattering layer that scatters polarized light of the first polarization direction; a polarizing layer that blocks polarized light of the first polarization direction and transmits polarized light of a second polarization direction that is orthogonal to the first polarization direction; and a reflective layer disposed between the polarized light scattering layer and the polarizing layer, wherein the reflective layer reflects light according to wavelength or polarization direction so as to selectively reflect the image light.

### Effects of the Invention

According to one configuration of the present invention, it is possible for the screen to improve the light usage efficiency of image light.

### BRIEF DESCRIPTION OF THE DRAWINGS

FIG. 1 is a cross-sectional view that shows a schematic configuration of a reflective projection display device according to an embodiment of the present invention.

FIG. 2 is a cross-sectional view that shows a schematic configuration of a screen included in the projection display device.

FIG. 3 shows the relationship between the refractive index of a base material of a polarized light scattering layer and the reflectance at an interface of the polarized light scattering layer and an adhesive.

FIG. 4 is a cross-sectional view that shows a schematic configuration of a reflective projection display device according to another embodiment of the present invention.

FIG. 5 is a cross-sectional view that shows a schematic configuration of a reflective projection display device according to another embodiment of the present invention.

FIG. 6 is a cross-sectional view that shows a schematic configuration of a reflective projection display device according to another embodiment of the present invention.

FIG. 7 is a cross-sectional view that shows a schematic configuration of a reflective projection display device according to another embodiment of the present invention.

FIG. 8 is a cross-sectional view that shows a schematic configuration of a reflective projection display device according to another embodiment of the present invention.

FIG. 9 is a cross-sectional view that shows a schematic configuration of a reflective projection display device according to another embodiment of the present invention.

FIG. 10 is a schematic diagram that shows transmissive states of the screen in the projection display device that correspond to voltage application/non-voltage application states.

FIG. 11 is a schematic diagram that shows transmissive states of the screen in the projection display device that correspond to voltage application/non-voltage application states.

FIG. 12 is a cross-sectional view that shows a schematic configuration of a reflective projection display device according to another embodiment of the present invention.

FIG. 13 is a cross-sectional view that shows a schematic configuration of a reflective projection display device according to another embodiment of the present invention.

FIG. 14 is a cross-sectional view that shows a schematic configuration of a reflective projection display device according to another embodiment of the present invention.

FIG. 15 is a cross-sectional view that shows a schematic configuration of a reflective projection display device according to another embodiment of the present invention.

FIG. 16 is a cross-sectional view that shows a schematic configuration of a reflective projection display device according to another embodiment of the present invention.

### DETAILED DESCRIPTION OF EMBODIMENTS

### Embodiment 1

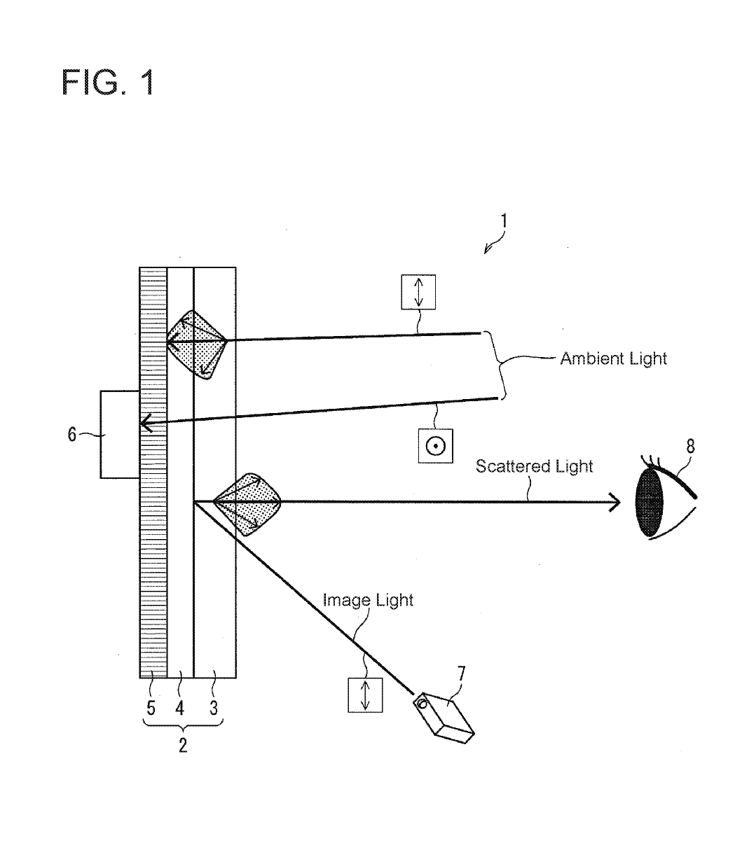

An embodiment of the present invention will be described hereafter with reference to FIGS. 1 to 3.

(Configuration of Projection Display Device 1)

FIG. 1 is a cross-sectional view that shows a schematic configuration of a reflective projection display device 1 according to the present embodiment. As shown in FIG. 1, the reflective projection display device 1 (a display/imaging device) includes: a screen 2; a camera 6 (imaging device) that images a viewer 8; and a projector 7 (projection device) that projects image light onto the screen 2.

The projection display device 1 of the present embodiment is a reflective projection display device; thus, the projector 7 and the viewer 8 are located on the same side of the screen 2. In addition, the camera 6 is disposed on the rear side (the side opposite to the viewer 8) of the screen 2 so as to be adjacent to the screen 2.

When the projection display device 1 is used as a display/imaging device for a videoconferencing system (interactive device), the camera 6 is located within the field of view of the screen (in the center, for example) with respect to the viewer 8. As a result, the line of sight of the viewer 8 viewing images projected onto the screen is essentially in the direction of the camera 6. Thus, a remote participant watching images captured by the camera 6 will feel that his/her line of sight matches that of the viewer 8. In other words, it is possible to use the projection display device 1 as a line of sight matching (eye contact) monitor. The various components forming the reflective projection display device 1 will be described later.

(Ambient Light)

Ambient light includes, for example, light from an illumination source or the like, natural light, and these forms of light after having been reflected by the viewer 8 or an object. As shown in FIG. 1, the ambient light includes a polarization component parallel to the paper surface of the drawings and a polarization component perpendicular to the paper surface of the drawings.

(Projector 7)

As shown in FIG. 1, the image light emitted from the projector 7 is polarized light (hereafter referred to as horizontally-polarized light) that is polarized in a direction parallel to the paper surface of the drawings. There is a variety of different types of projectors; however, taking into consideration the polarization and diffraction efficiency of holograms, it is preferable to use a laser projector having a laser light source that can restrict polarization direction and wavelength. A laser light source emits light that has a substantially uniform wavelength and that has a narrow beam spread angle. Thus, a projector 7 that utilizes a laser light source is useful in generating image light that will be reflected by a reflective holographic film 4, which will be described later. Alternatively, a lens imaging optical projector that utilizes lenses may be used. At such time, a polarizing plate, a wire grid polarizing plate, or the like may be used in order to control polarization.

(Camera 6)

The camera 6 images the viewer 8 (subject) or another subject on the viewer 8 side of the screen 2. The camera 6 receives ambient light that has passed through the screen 2. The periphery of the camera 6 is enclosed by a casing.

(Screen 2)

The screen 2 scatters image light toward the viewer 8 such that the viewer 8 is able to see the image light. Meanwhile, the screen 2 prevents image light from being transmitted toward the camera 6 and transmits ambient light toward the camera 6. In addition, the screen 2 transmits ambient light from the camera 6 side toward the viewer 8 side. As a result, the viewer 8 is able to see images projected onto the screen 2 and also see the other side of the screen 2.

The screen 2 includes: a polarized light scattering film as a polarized light scattering layer 3; a holographic film 4 (reflective layer); and a polarizing plate as the polarizing layer 5. In addition, the polarized light scattering layer 3, the holographic film 4, and the polarizing layer 5 are stacked in this order from the viewer 8 side such that the polarized light scattering layer 3 is disposed on the projector 7 side.

(Polarized Light Scattering Layer 3)

The polarized light scattering layer 3 scatters image light. The polarized light scattering layer 3 used in the present embodiment is a polarized light scattering film that has polarized light scattering anisotropic characteristics (characteristics in which the degree of scattering varies according to the polarization direction). The polarized light scattering film has a transmission axis and a scattering axis that are parallel to the plane of the light scattering film and that are orthogonal to each other. The polarized light scattering film transmits, without scattering, light in which the polarization direction matches the transmission axis, while scattering a portion of the light in which the polarization direction matches the scattering axis. The scattering axis of the polarized light scattering layer 3 is parallel to the paper surface of the drawings, and the transmission axis of the polarized light scattering layer 3 is perpendicular to the paper surface of the drawings. The degree to which the polarized light scattering layer 3 scatters polarized light in which the polarization direction matches the scattering axis (hereafter referred to as horizontally-polarized light) is larger than the degree to which the polarized light scattering layer 3 scatters polarized light in which polarization direction matches the transmission axis (hereafter referred to as vertically-polarized light). The degree of scattering can be represented by the haze value, for example.

The scattering axis of the polarized light scattering layer 3 is disposed so as to match the polarization direction of the image light. Thus, the polarized light scattering layer 3 scatters the image light (horizontally-polarized light) to a larger extent than the vertically-polarized light included in ambient light.

(Holographic Film 4)

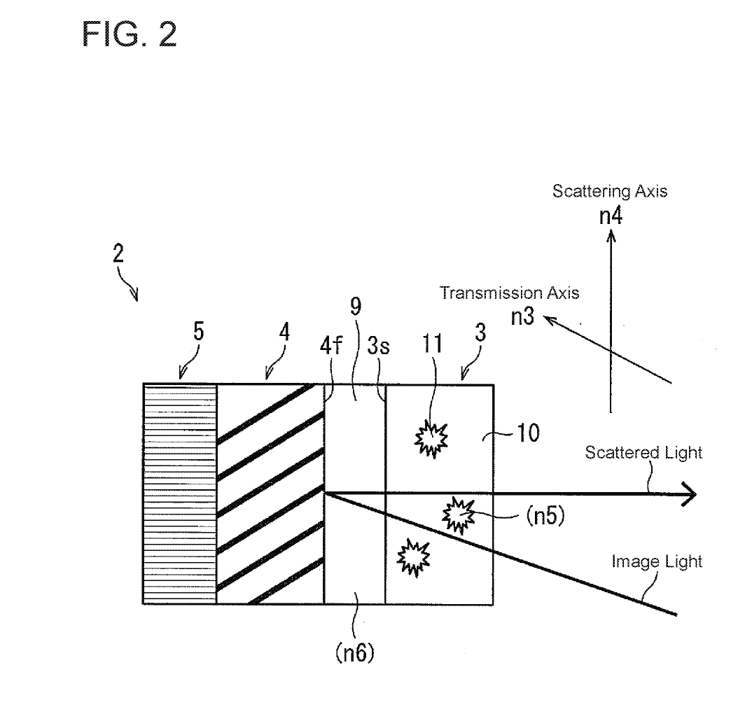

The reflective layer reflects light from the viewer 8 side that has passed through the polarized light scattering layer 3 back toward the viewer 8 side. In the present embodiment, a reflective holographic film 4 (a reflective hologram such as a Lippmann hologram) is used as the reflective layer. As shown in FIG. 2, image light from the projector 7 that enters a surface 4f side of the holographic film 4 via the polarized light scattering layer 3 is diffracted by the holographic film 4 and reflected toward the viewer 8.

The reflective holographic film 4 has a structure in which two types of layers with differing refractive indices are alternately stacked. As a result of diffraction that occurs due to the difference between the refractive indices, the reflective holographic film 4 reflects light that is within a prescribed wavelength range and transmits light that is outside this wavelength range. The reflective holographic film 4 has a strong wavelength selectivity for reflecting light (the wavelength range that will be reflected is narrow). The reflective holographic film 4 reflects mainly light that is within a wavelength range that corresponds to light emitted from the light source of the projector 7 and is able to transmit light that is outside this wavelength range. It is preferable that, in this manner, the wavelength at the peak intensity of light emitted from the light source of the projector 7 be included in the prescribed wavelength range reflected by the reflective holographic film 4. The reflective holographic film 4 can also respectively reflect a plurality of separate wavelength ranges. Thus, the reflective holographic film 4 can reflect light in a plurality of mutually separate wavelength ranges that correspond to wavelengths (R: λ1, G: λ2, B: λ3, for example) of light emitted from a plurality of light sources in a projector 7 that projects color images. Among these plurality of wavelength ranges, the wavelength λ1 is included in a first wavelength range, the wavelength λ2 is included in a second wavelength range, and the wavelength λ3 is included in a third wavelength range. The reflective holographic film 4 transmits light at most wavelengths, other than the wavelengths λ1, λ2, and λ3 (the first to third wavelength ranges). In summary, the reflective holographic film 4 selectively reflects light at wavelengths used by the projector 7, and transmits light at other wavelengths included in ambient light.

(Polarizing Layer 5)

The polarizing layer 5 selectively blocks light that is not necessary for imaging via the camera 6, or in other words, image light. Specifically, the polarizing layer 5 is a polarizing plate that blocks horizontally-polarized light. The polarizing layer 5 blocks (absorbs or reflects) image light that is horizontally polarized and horizontally-polarized light contained in ambient light. The polarizing layer 5 transmits only ambient light that is vertically polarized. Since the image light is blocked by the polarizing layer 5, the image light does not enter the camera 6. The polarizing layer 5 and the polarized light scattering layer 3 are disposed such that the transmission axis of the polarizing layer 5 is parallel to the transmission axis of the polarized light scattering layer 3.

The polarizing layer 5 may be a polarization-selective dielectric mirror that reflects (blocks) horizontally-polarized light and transmits vertically-polarized light. In such a case, the polarizing layer 5 that is a polarization-selective dielectric mirror reflects (blocks) image light that is horizontally polarized toward the viewer 8, and transmits only ambient light that is vertically polarized. As a result, a portion of the image light that passed through the reflective holographic film 4 is reflected by the polarizing layer 5 that is a polarization-selective dielectric mirror, and this light is used to display images.

(Detailed Configuration of Screen 2)

FIG. 2 is a cross-sectional view that shows a schematic configuration of the screen 2 included in the reflective projection display device 1. As shown in the drawings, the polarized light scattering layer 3, the holographic film 4, and the polarizing layer 5 are stacked in the screen 2 in this order from the viewer 8 side. The polarized light scattering layer 3 and the holographic film 4 and bonded to each other via an adhesive 9. The adhesive 9 is formed in a layer between the polarized light scattering layer 3 and the holographic film 4.

The refractive indices of the two types of layers in the reflective holographic film 4 are respectively represented by n1 and n2. In addition, the refractive index of the cured adhesive 9 is represented by n6.

The polarized light scattering layer 3 (polarized light scattering film) includes: a base material 10 that is birefringent; and scattering microparticles 11 that are dispersed within the base material 10. In the base material 10, the refractive index along the transmission axis is represented by n3, and the refractive index along the scattering axis is represented by n4. N3 and n4 are different from one another. In addition, the refractive index of the scattering microparticles 11 is not related to the polarization direction of the light, and is represented by n5. N5 and n4 are different from one another. If the difference in the refractive indices (the difference between the refractive index of the scattering microparticles 11 and the refractive index of the base material 10) at the interface of the scattering microparticles 11 is large, then the reflectance and refraction become larger at the interface of the scattering microparticles 11. Here, |n4−n5|>|n3−n5| is satisfied. Thus, the reflectance (or difference in the refractive indices) at the interface (surface) of the scattering microparticles 11 along the scattering axis is larger than the reflectance (or difference in the refractive indices) at the interface of the scattering microparticles 11 along the transmission axis. In addition, it is preferable that the reflectance (or difference in the refractive indices) at the interface of the scattering microparticles 11 along the transmission axis be small; thus, it is preferable that n3 be essentially equal to n5. The polarized light scattering layer 3 scatters light via reflection and/or refraction by the scattering microparticles 11 in accordance with the difference in the refractive indices of the base material 10 and the scattering microparticles 11. As a result, in the polarized light scattering layer 3, the degree of scattering of polarized light in which the polarization direction matches the scattering axis is greater than the degree of scattering of light in which the polarization direction matches the transmission axis.

Light that has passed through the polarized light scattering layer 3 enters the adhesive 9 layer. It is preferable that polarized light in which the polarization direction is along the transmission axis not be reflected at the interface of the adhesive 9 and the polarized light scattering layer 3. Meanwhile, it is preferable that polarized light in which the polarization direction is along the scattering axis be reflected at the interface of the adhesive 9 and the polarized light scattering layer 3. Thus, it is preferable that |n4−n6|>|n3−n6| be satisfied, and it is even more preferable that n6 be essentially equal to n3. By using such an adhesive 9, it is possible for a portion of image light (horizontally-polarized light) that has passed through the polarized light scattering layer 3 to be reflected toward the viewer 8 at the interface of the adhesive 9 and the polarized light scattering layer 3.

Microscopic protrusions and recesses may be provided on a surface 3s on the adhesive 9 side of the polarized light scattering layer 3. As a result, it is possible to provide a large degree of scattering of only image light (horizontally-polarized light) at the interface of the adhesive 9 and the polarized light scattering layer 3. The surface on the adhesive 9 side of the polarized light scattering layer 3 may be made of lenticular lenses formed in parallel in the vertical direction, for example. In such a case, it is possible to provide a large degree of refraction (lens effect) of only image light (horizontally-polarized light) at the interface of the adhesive 9 and the polarized light scattering layer 3. As a result, it is possible to efficiently widen in the horizontal direction the viewing angle in which image light projected onto the screen 2 is visible.

It is possible to use PET (polyethylene terephthalate), for example, as the base material 10 of the polarized light scattering layer 3 (the polarized light scattering film). In such a case, the refractive index along the transmission axis can be set to n3=1.6, and the refractive index along the scattering axis can be set to n4=1.75, for example. It is possible to use an acrylic adhesive (refractive index of 1.56), a silicon adhesive, an epoxy adhesive, or the like, for example, as the adhesive 9.

In addition, in order to improve reliability by reinforcing the holographic film 4, a protective film that protects the holographic film 4 may be provided between the holographic film 4 and the adhesive 9. In addition, since the holographic film 4 is reflective, the film 4 is relatively easy to manufacture.

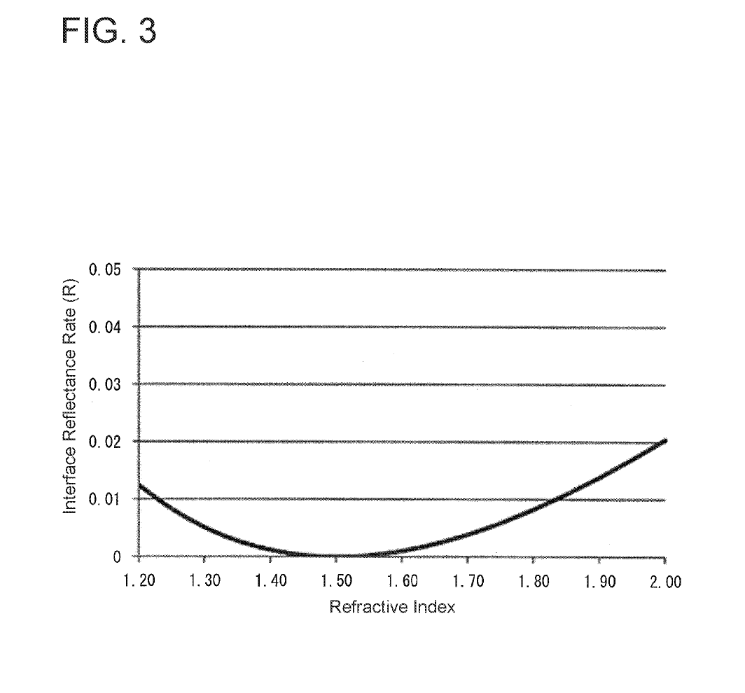

FIG. 3 shows the relationship between the refractive index of the base material 10 of the polarized light scattering layer 3 and the reflectance R at the interface of the polarized light scattering layer 3 and the adhesive 9. FIG. 3 shows the reflectance R when the refractive index n6 of the adhesive 9 is 1.5.

When the refractive index of the base material 10 of the polarized light scattering layer 3 is the same as the refractive index (1.5) of the adhesive 9, interface reflectance does not occur. In such a case, scattering does not occur even if the interface of the polarized light scattering layer 3 and the adhesive 9 has recesses and protrusions. Therefore, it is preferable that the difference between the refractive index n3 along the transmission axis of the base material 10 of the polarized light scattering layer 3 and the refractive index n6 of the adhesive 9 be small.

Meanwhile, as the difference between the refractive index n6 of the adhesive 9 and the refractive index of the base material 10 of the polarized light scattering layer 3 becomes larger, the interface reflectance R becomes larger and scattering is more likely to occur. Therefore, it is preferable that the difference between the refractive index n4 along the scattering axis of the base material 10 of the polarized light scattering layer 3 and the refractive index n6 of the adhesive 9 be large.

(Effects)

Image light (horizontally-polarized light) that enters the screen 2 from the viewer 8 side is scattered in the polarized light scattering layer 3. The scattering properties of the polarized light scattering film are generally inadequate; thus, a large amount of image light passes through the polarized light scattering layer 3. A portion of the image light that has passed through the polarized light scattering layer 3 is reflected at the interface of the adhesive 9 and the polarized light scattering layer 3. Furthermore, image light that passes through the adhesive 9 is reflected toward the viewer 8 via the diffraction effect of the reflective holographic film 4. The image light reflected toward the viewer 8 by the adhesive 9 and the reflective holographic film 4 is scattered again by the polarized light scattering layer 3. Since image light is scattered in the screen 2 twice by the polarized light scattering layer 3, the screen 2 can scatter more image light compared to a conventional configuration. In other words, it is possible to greatly improve the light usage efficiency of image light. This contributes to a decrease in the power consumption and light output of the projector 7. In addition, even if a portion of the image light passes through the holographic film 4, the polarizing layer 5 blocks the image light, which is horizontally polarized. The reflective holographic film 4 can also selectively reflect with a high reflectance light at wavelengths that correspond to image light. Thus, even if the polarization direction of a portion of the image light has shifted as a result of being scattered by the polarized light scattering layer 3, it is possible to reflect this image light, in which the polarization direction has shifted, toward the viewer 8 by means of the reflective holographic film 4. Thus, it is possible to prevent image light from entering the camera 6. As a result, it is possible to improve the quality of images displayed on the screen 2, and to also improve the quality of images captured by the camera 6.

Meanwhile, vertically-polarized light contained in ambient light that enters the screen 2 from the viewer 8 side passes through the polarized light scattering layer 3 and the adhesive 9. The reflective holographic film 4 reflects light (light corresponding to wavelengths used by the projector 7) at a portion of the wavelengths contained in ambient light, and transmits light at most of the other wavelengths contained in ambient light. Vertically-polarized ambient light that passed through the holographic film 4 passes through the polarizing layer 5 and reaches the camera 6. As a result, the camera 6 is able to capture ambient light (in other words, the subject), which does not include image light.

Since the scattering properties of the polarized light scattering layer 3 are inadequate, the polarized light scattering layer 3 may provide a small amount of scattering (fine scattering) to the portion of the polarized light (vertically-polarized light) in which the polarization direction matches the transmission axis. Since vertically-polarized light passes through the polarizing layer 5, the scattered vertically-polarized light causes blurriness in captured images. In the projection display device 1, the camera 6 is disposed adjacent to the screen 2. In this manner, since the distance between the camera 6 and the polarized light scattering layer 3 is small, the projection display device 1 can minimize the effects (blurring) of the small amount of scattering of the vertically-polarized light.

In addition, from among the ambient light that enters the screen 2 from the camera 6 side, light that is vertically-polarized and is at a wavelength that is not reflected by the holographic film 4 passes through the screen 2 and reaches the viewer 8. Thus, the screen 2 functions as a transparent screen.

In addition, it is possible to set the propagation direction of diffracted light (reflected light) in the reflective holographic film 4 when the hologram is manufactured. Thus, it is possible in the projection display device 1 to set the viewing angle of images to a desired angle.

### Embodiment 2

Another embodiment of the present invention will be described hereafter. In the present embodiment, a polarization-selective dielectric mirror is used as the reflective layer in place of the holographic film 4 of Embodiment 1. For ease of description, members in the following embodiment that have the same function as members in the above-mentioned embodiment will have the same reference character and a description thereof will be omitted.

(Configuration of Projection Display Device 21)

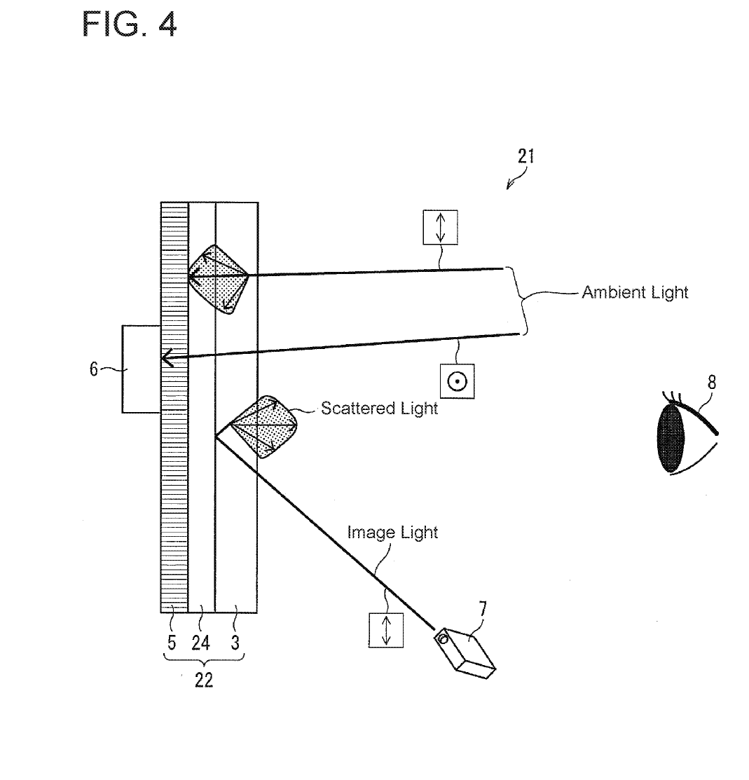

FIG. 4 is a cross-sectional view that shows a schematic configuration of a reflective projection display device 21 according to the present embodiment. As shown in FIG. 4, the reflective projection display device 21 (a display/imaging device) includes: a screen 22; the camera 6; and the projector 7.

(Screen 22)

The screen 22 includes: the polarized light scattering layer 3; a polarization-selective dielectric mirror 24 (reflective layer); and the polarizing layer 5. In addition, the polarized light scattering layer 3, the polarization-selective dielectric mirror 24, and the polarizing layer 5 are stacked in this order from the viewer 8 side such that the polarized light scattering layer 3 is disposed on the projector 7 side.

(Polarization-Selective Dielectric Mirror 24)

In the present embodiment, a polarization-selective dielectric mirror 24 (a polarization-selective mirror) is used as the reflective layer. The polarization-selective dielectric mirror 24 selectively reflects light in accordance with the polarization direction. The mirror 24 reflects image light and horizontally-polarized light, and transmits vertically-polarized light. Since the polarization-selective dielectric mirror 24 need reflect only image light, it is preferable that the mirror 24 have the property (wavelength selectivity) of mainly reflecting wavelengths (wavelengths [R: λ1, G: λ2, B: λ3, for example] of light emitted from a plurality of light sources in the projector 7) used in image light. The plurality of wavelengths at the peak intensities of light emitted from the plurality of light sources in the projector 7 are included in the prescribed wavelength ranges in which horizontally-polarized light is reflected by the polarization-selective dielectric mirror 24. A D-BEF film manufactured by 3M, or the like, for example, can be used as the polarization-selective dielectric mirror 24.

(Effects)

Image light from the projector 7 that enters the polarization-selective dielectric mirror 24 via the polarized light scattering layer 3 is reflected by the polarization-selective dielectric mirror 24 toward the viewer 8. Horizontally-polarized light (image light) reflected by the polarization-selective dielectric mirror 24 is once again scattered in the polarized light scattering layer 3. Thus, it is possible to greatly improve the light usage efficiency of image light.

Meanwhile, of the ambient light that enters the polarization-selective dielectric mirror 24, horizontally-polarized light is reflected by the polarization-selective dielectric mirror 24, and vertically-polarized light passes through the polarization-selective dielectric mirror 24. Vertically-polarized ambient light that passed through the polarization-selective dielectric mirror 24 passes through the polarizing layer 5 and reaches the camera 6. As a result, the camera 6 is able to capture ambient light (in other words, the subject), which does not include image light.

### Embodiment 3

Another embodiment of the present invention will be described hereafter. In the present embodiment, a reflective holographic film and a polarization-selective dielectric mirror are both used as the reflective layer.

(Configuration of Projection Display Device 31)

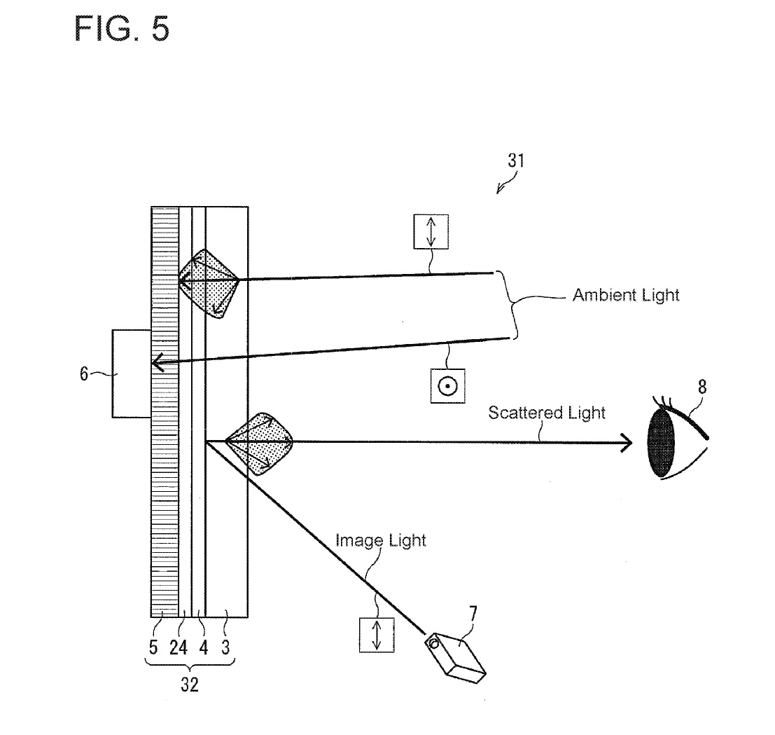

FIG. 5 is a cross-sectional view that shows a schematic configuration of a reflective projection display device 31 according to the present embodiment. The reflective projection display device 31 includes: a screen 32; the camera 6; and the projector 7.

(Screen 32)

The screen 32 includes: the polarized light scattering layer 3; the holographic film 4; the polarization-selective dielectric mirror 24; and the polarizing layer 5. The holographic film 4 is disposed on the polarized light scattering layer 3 side of the polarization-selective dielectric mirror 24. The holographic film 4 and the polarization-selective dielectric mirror 24 may be arranged in the reverse order, however. The holographic film 4 and the polarization-selective dielectric mirror 24 function as a reflective layer. The respective configurations of the holographic film 4 and the polarization-selective dielectric mirror 24 are the same as in Embodiments 1 and 2.

(Effects)

In the present embodiment, it is possible to have image light that passed through the holographic film 4 be reflected by the polarization-selective dielectric mirror 24. Thus, it is possible to further improve the light usage efficiency of image light.

In addition, during reflection by the polarization-selective dielectric mirror 24, the angle of incidence and the angle of reflection are equal to each other. Meanwhile, during reflection (diffraction) by the reflective holographic film 4, the angle of incidence and the angle of reflection of the image light are different from each other. Thus, since the holographic film 4 and the polarization-selective dielectric mirror 24 reflect image light in respectively different directions, the directions in which the reflected light is scattered by the polarized light scattering layer 3 also differ from each other. Thus, it is possible to scatter image light at a wider angle range by combining two reflective layers (the holographic film 4 and the polarization-selective dielectric mirror 24). Therefore, it is possible, via the holographic film 4 and the polarization-selective dielectric mirror 24, to control the viewing angle so as to be within a desired range and to expand the viewing angle of the projection display device 31.

### Embodiment 4

Another embodiment of the present invention will be described hereafter. In the present embodiment, the viewing angle is increased by forming lenses inside the polarized light scattering layer.

(Configuration of Projection Display Device 41)

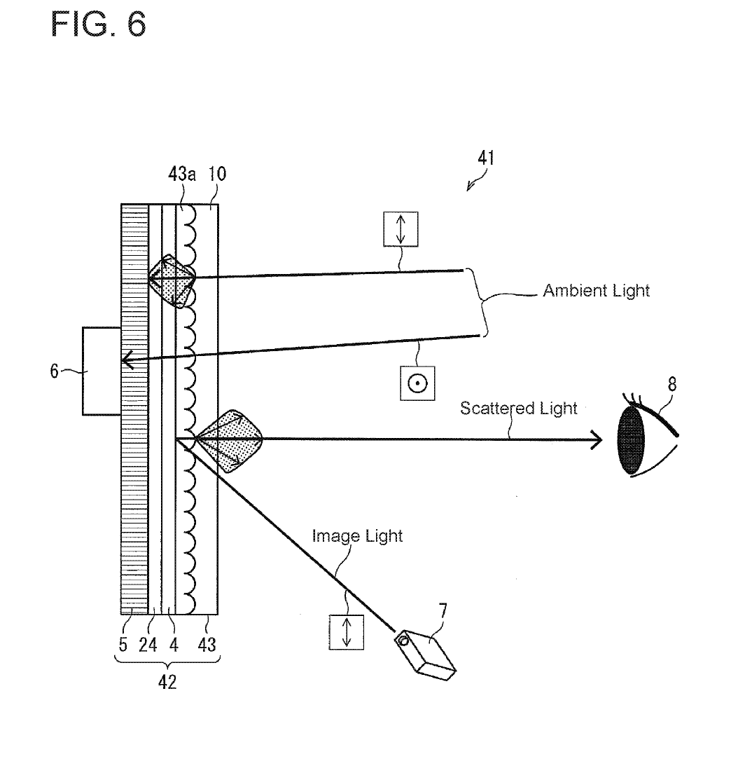

FIG. 6 is a cross-sectional view that shows a schematic configuration of a reflective projection display device 41 according to the present embodiment. The reflective projection display device 41 includes: a screen 42; the camera 6; and the projector 7.

The screen 42 includes: a polarized light scattering layer 43; the holographic film 4; the polarization-selective dielectric mirror 24 (reflective layer); and the polarizing layer 5.

(Polarized Light Scattering Layer 43)

The polarized light scattering layer 43 is a polarized light scattering film, and includes: a birefringent base material 10; and lenticular lenses 43a (lens-shaped bodies). In the base material 10, the refractive index along the transmission axis is represented by n3, and the refractive index along the scattering axis is represented by n4. Scattering microparticles 11 may or not may be dispersed within the base material 10. The refractive index of the lenticular lenses 43a is not related to the polarization direction, and is the same as the refractive index n3 along the transmission axis in the base material 10. The lenticular lenses 43a have a shape in which a plurality of semicylindrical lenses are disposed in parallel to each other. The extension direction of the semicylindrical shape of the lenticular lenses 43 may be the vertical direction or the horizontal direction of the screen.

The refractive index of the lenticular lenses 43a is the same as the refractive index n3 of the base material 10 along the transmission axis. Thus, at the interface of the lenticular lenses 43a and the base material 10, polarized light (vertically-polarized light) in which the polarization direction is along the transmission axis is not refracted or reflected.

Meanwhile, the refractive index of the lenticular lenses 43a is different from the refractive index n4 of the base material 10 along the scattering axis. Thus, at the interface of the lenticular lenses 43a and the base material 10, polarized light (horizontally-polarized light) in which the polarization direction is along the scattering axis is refracted and reflected. Since the lenticular lenses 43a are a group of microscopic lens shapes, refraction and reflection at the interface of the lenticular lenses 43a and the base material 10 provide the effect of scattering image light (horizontally-polarized light). The lenticular lenses 43a refract and reflect the polarized light that was reflected by the reflective layer (the holographic film 4 and the polarization-selective dielectric mirror 24). In this manner, the lenticular lenses 43a formed in the polarized light scattering layer 43 have polarization selectivity.

If the surface shape of the lenticular lenses 43a is changed, the direction in which the polarized light is scattered also changes. Thus, by adjusting the surface shape of the lenticular lenses 43a, it is possible to scatter image light at a desired viewing angle, and to also expand the viewing angle.

In this example, the lens-shaped bodies formed in the polarized light scattering layer 43 were lenticular lenses 43a. The present embodiment is not limited to this, however, and a large number of microlenses of a desired shape may be formed as the lens-shaped bodies. In addition, microscopic recesses and protrusions may be formed as the lens-shaped bodies. The lens-shaped bodies are formed along the entire polarized light scattering layer 43.

### Embodiment 5

Another embodiment of the present invention will be described hereafter. In the present embodiment, a light absorption layer that covers a region in which the camera is not disposed is provided in the screen.

(Configuration of Projection Display Device 51)

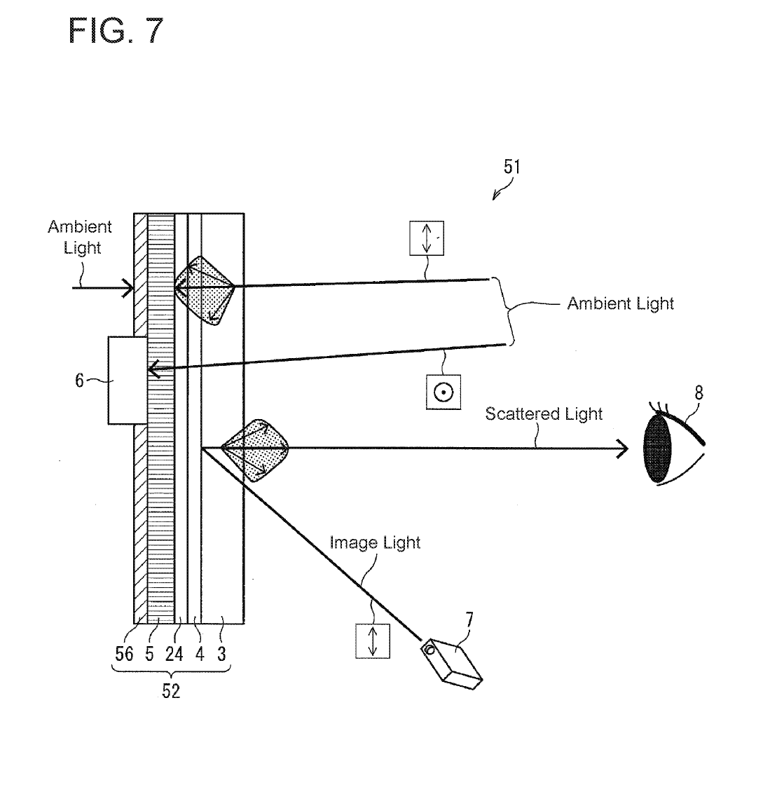

FIG. 7 is a cross-sectional view that shows a schematic configuration of a reflective projection display device 51 according to the present embodiment. The reflective projection display device 51 includes: a screen 52; the camera 6; and the projector 7.

(Screen 52)

The screen 52 includes: the polarized light scattering layer 3; the holographic film 4; the polarization-selective dielectric mirror 24 (reflective layer); the polarizing layer 5; and a light absorption layer 56. Here, the light absorption layer 56 is disposed on the camera 6 side of the polarizing layer 5. The present embodiment is not limited to this, however, and the light absorption layer 56 may be provided between the polarizing layer 5 and the reflective layer (the holographic film 4 and the polarization-selective dielectric mirror 24).

(Light Absorption Layer 56)

The light absorption layer 56 covers a region on the screen 52 in which the camera 6 is not disposed. The light absorption layer 56 absorbs visible light, which is captured by the camera (in other words, the layer 56 is black). Even in a case in which the light absorption layer 56 is disposed to the viewer 8 side of the polarizing layer 5, the light absorption layer 56 is not provided in a region corresponding to the camera 6 (in other words, light is transmitted in the region corresponding to the camera 6). The light absorption layer 56 may be provided so as to also cover the rear side (the side opposite to the viewer 8) of the camera 6. Since the screen 52 includes the light absorption layer 56, the screen is not a transparent screen.

(Effects)

Light that enters the screen 52 from the side (the camera 6 side) opposite to the viewer 8 is blocked by the light absorption layer 56. In addition, in the region in which the camera 6 is disposed, light that enters the screen 52 from the side opposite to the viewer 8 is blocked by the camera 6. Thus, when there is no image light (during black display), the projection display device 51 can provide an excellent black display since the screen 52 does not transmit ambient light from the side opposite to the viewer 8. In addition, the projection display device 51 can perform display with high contrast.

When there is no light absorption layer 56, the viewer 8 is able to see the camera on the other side of the screen. Being able to see the camera makes it difficult for the viewer 8 to be able to focus on the images being displayed on the screen.

Meanwhile, in the projection display device 51 of the present embodiment, light is absorbed by the light absorption layer 56 and the camera 6; thus, it is possible to make the camera 6 less visible to the viewer 8. In other words, it is possible to configure the projection display device 51 such that the camera 6 is not visible to the viewer 8. Thus, it is possible to use the projection display device 51 as an “eye contact monitor” that prevents the viewer 8 from noticing the camera.

### Embodiment 6

Another embodiment of the present invention will be described hereafter. In the present embodiment, a wave plate is provided between the polarizing layer and the light absorption layer of Embodiment 5.

(Configuration of Projection Display Device 61)

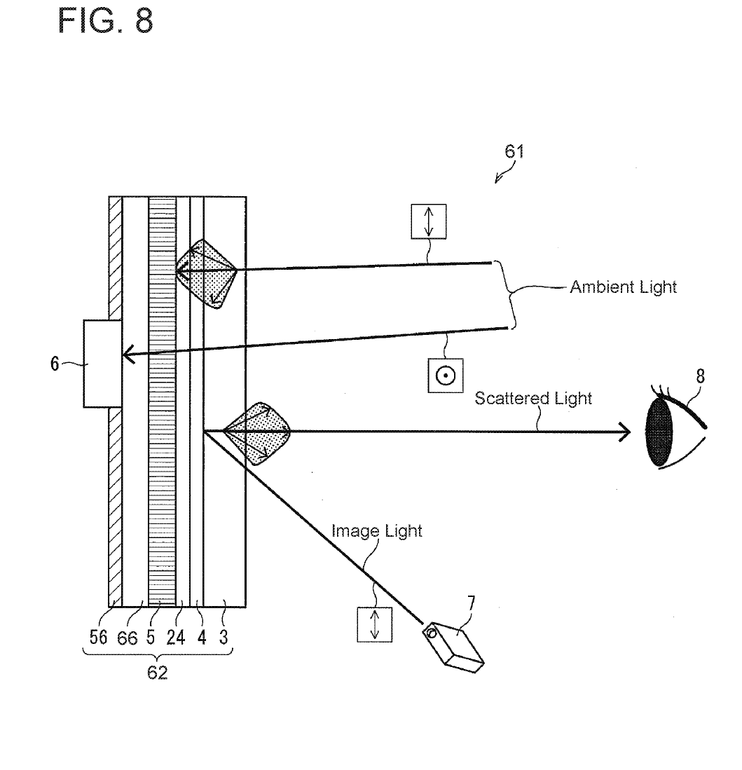

FIG. 8 is a cross-sectional view that shows a schematic configuration of a reflective projection display device 61 according to the present embodiment. The reflective projection display device 61 includes: a screen 62; the camera 6; and the projector 7. The casing (the portion other than the lens) of the camera 6 can be made of a material (a metal, for example) that maintains a polarization state during reflection.

(Screen 62)

The screen 62 includes: the polarized light scattering layer 3; the holographic film 4; the polarization-selective dielectric mirror 24; the polarizing layer 5; a quarter-wave plate 66; and the light absorption layer 56. The quarter-wave plate is disposed on the camera 6 side of the polarizing layer 5 and the viewer 8 side of the light absorption layer 56. A light absorption layer 56 is provided in this example; however, such a layer may not be provided.

(Quarter-Wave Plate 66)

The quarter-wave plate 66 (a π/2 retardation plate) provides a quarter-wavelength shift (a retardation of π/2) to a specified wavelength or the center wavelength (or the wavelength λ2 that corresponds to G) within the wavelength range of ambient light or image light. The slow axis of the quarter-wave plate 66 is inclined at an angle of 45° with respect to the transmission axis of the polarizing layer 5 (the polarizing plate). Thus, the quarter-wave plate 66 converts vertically-polarized light transmitted by the polarizing layer 5 into circularly-polarized light.

(Effects)

A portion of the light that reaches the camera 6 is reflected toward the viewer 8 by the surface of the casing of the camera 6. If the light reflected by the camera 6 returns to the viewer 8 side, differences in brightness will occur between the camera 6 region and any other regions (the regions where the absorption layer 56 is disposed), and the viewer 8 will be able to see the camera 6.

In the present embodiment, ambient light (vertically-polarized light) that enters from the viewer 8 side and passes through the polarizing layer 5 is converted into circularly-polarized light by the quarter-wave plate 66. The polarization state of the circularly-polarized light is maintained during reflection by the casing of the camera 6. The circularly-polarized light reflected by the casing of the camera 6 again enters the quarter-wave plate 66. The circularly-polarized light that once again entered the quarter-wave plate 66 is converted into linearly-polarized light (horizontally-polarized light) by the quarter-wave plate 66. At such time, light that has passed through the quarter-wave plate 66 has been converted into horizontally-polarized light in which the polarization direction has been changed by 90° from the initial vertical polarization. Thus, horizontally-polarized light that has passed through the quarter-wave plate 66 is blocked (absorbed) by the polarizing layer 5.

Thus, the projection display device 61 of the present embodiment is able to reduce the amount of light reflected by the camera 6 toward the viewer 8. Therefore, the projection display device 61 is able to reduce the visibility of the camera with respect to the viewer 8. In addition, the projection display device 61 is able to realize an excellent black display and high contrast.

### Embodiment 7

Another embodiment of the present invention will be described hereafter. In the present embodiment, the screen is switched between being transparent and non-transparent via liquid crystal.

(Configuration of Projection Display Device 71)

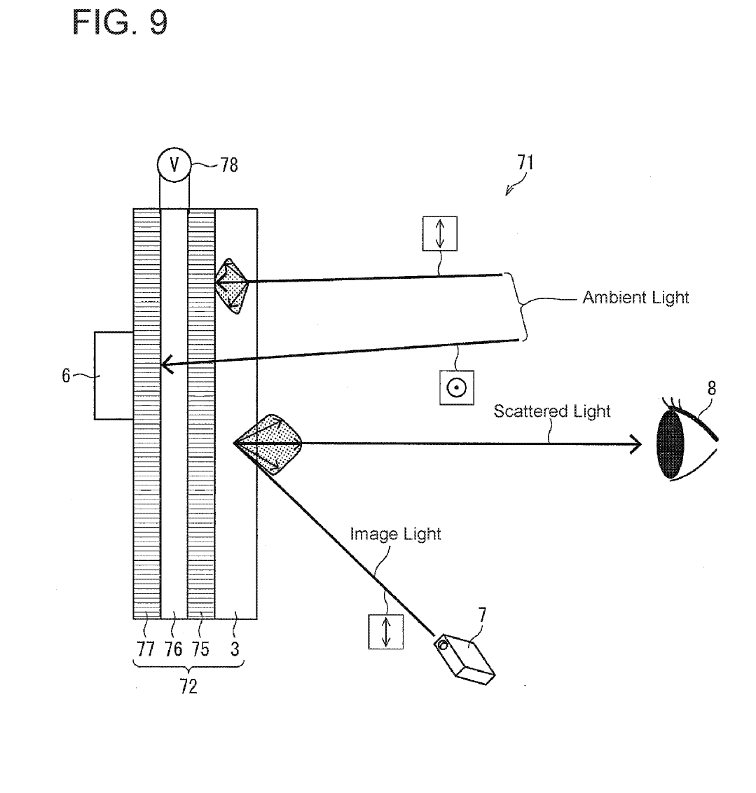

FIG. 9 is a cross-sectional view that shows a schematic configuration of a reflective projection display device 71 according to the present embodiment. The reflective projection display device 71 includes: a screen 72; the camera 6; and the projector 7.

(Screen 72)

The screen 72 includes, stacked in the following order from the viewer 8 side: the polarized light scattering layer 3; a first polarizing plate 75 (a first polarizing layer); a liquid crystal layer 76; and a second polarizing plate 77 (a second polarizing layer). The liquid crystal layer 76 is disposed between the two polarizing plates (the first polarizing plate 75 and the second polarizing plate 77). The screen 72 further includes a power source 78 provided for the liquid crystal layer 76.

(First Polarizing Plate 75, Liquid Crystal Layer 76, Second Polarizing Plate 77)

The absorption axis (the axis orthogonal to the transmission axis) of the first polarizing plate 75 is parallel to the scattering axis of the polarized light scattering layer 3. The absorption axis of the second polarizing plate 77 is orthogonal to the absorption axis of the first polarizing plate 75. In other words, the first polarizing plate 75 and the second polarizing plate 77 are disposed in a crossed Nicols state.

The screen 72 is configured such that voltage can be applied by the power source 78 to both end faces of the liquid crystal layer 76. The liquid crystal layer 76 switches between changing and not changing the polarization direction of light that passes therethrough in accordance with whether voltage is being applied or not being applied. It is possible to appropriately set whether the polarization direction is changed when voltage is applied or the polarization direction is changed when no voltage is applied (in other words, whether the screen is a normally-black screen or a normally-white screen). The liquid crystal layer may have a cell structure enclosed by glass, or a film structure.

(Effects)

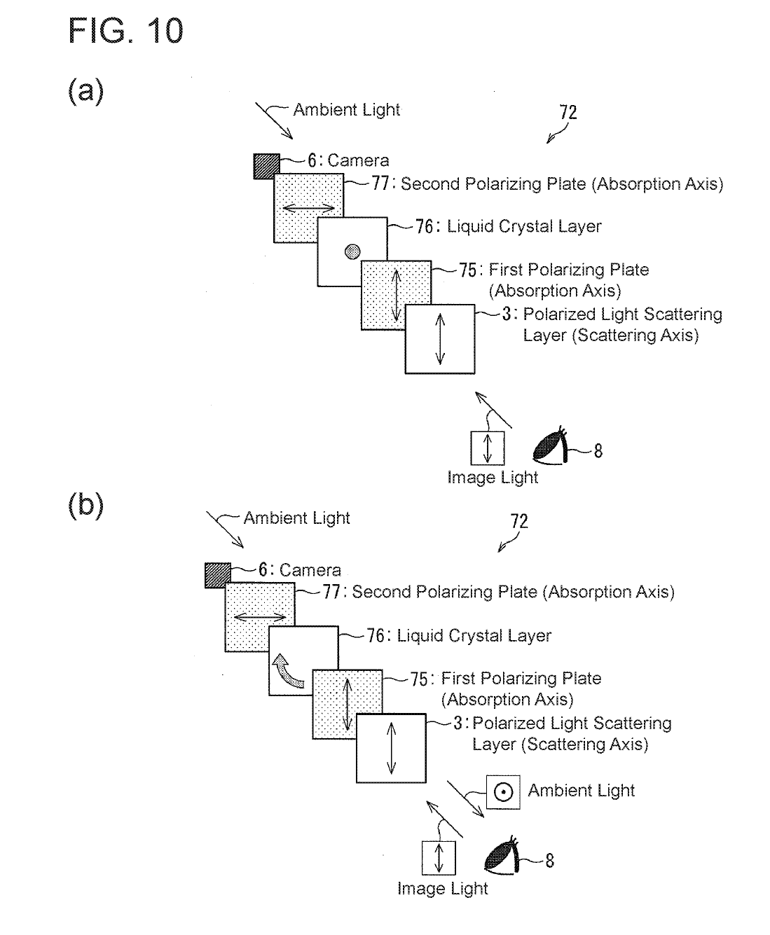

FIG. 10 is a schematic diagram that shows transmissive states of the screen 72 that correspond to voltage application/non-voltage application states. FIG. 10 shows the scattering axes and absorption axes for the various layers. Here, a vertical arrow indicates the same orientation as horizontally-polarized light and a horizontal arrow indicates the same orientation as vertically-polarized light.

In FIG. 10(a), the liquid crystal layer 76 is in a first state that does not change the polarization direction of light. In such a case, vertically-polarized light (a portion of ambient light) that enters the screen 72 from the viewer 8 side passes through the first polarizing plate 75, but is blocked by the second polarizing plate 77. Image light (horizontally-polarized light) is blocked by the first polarizing plate 75. Thus, since no light reaches the camera 6, imaging by the camera 6 is turned OFF. In addition, ambient light that enters the screen 72 from the side opposite to the viewer 8 is blocked by the second polarizing plate 77 and the first polarizing plate 75. Thus, in this first state, the screen 72 can obtain a high OD (optical density) value, or in other words, can provide an excellent black display at high contrast.

In FIG. 10(b), the liquid crystal layer 76 is in a second state that changes the polarization direction of light by 90°. In such a case, vertically-polarized light (a portion of ambient light) that enters the screen 72 from the viewer 8 side passes through the first polarizing plate 75, is converted to horizontally-polarized light by the liquid crystal layer 76, and passes through the second polarizing plate 77. Similarly, a portion (horizontally-polarized light) of ambient light that enters the screen 72 from the side opposite to the viewer 8 passes through the second polarizing plate 77, is converted to vertically-polarized light by the liquid crystal layer 76, and passes through the first polarizing plate 75. Thus, in the second state, the screen 72 functions as a transparent screen. In addition, imaging by the camera 6 is turned ON, and it is possible to image the subject via the camera 6.

In this manner, the projection display device 71 can perform a hybrid display that switches between a first state that prioritizes contrast during the display of image light and a second state that allows for imaging by the camera 6 and allows the screen to function as a transparent screen.

An example was described above in which two polarizing plates (the first polarizing plate 75 and the second polarizing plate 77) were disposed in a crossed Nicols state. It is also possible to obtain a similar effect if the polarizing plates are disposed in a parallel Nicols state, however. If the polarizing plates are disposed in a parallel Nicols state, the relationship between the first state/second state and voltage application/non-voltage application is the opposite from that described above.

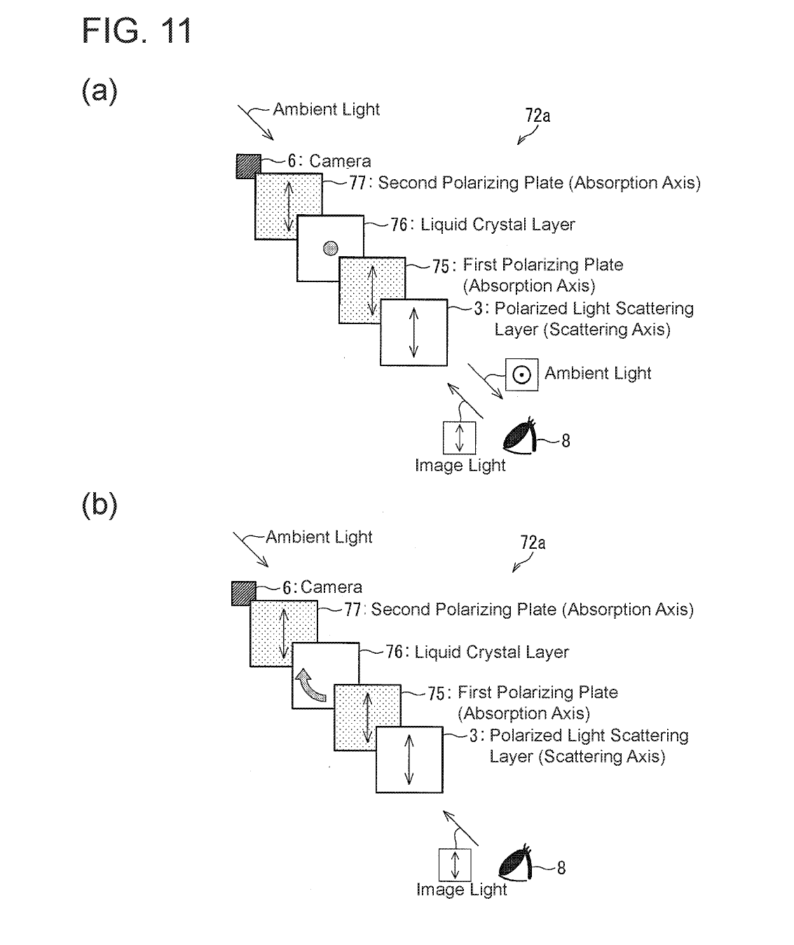

FIG. 11 is a schematic diagram that shows transmissive states of a screen 72a that correspond to voltage application/non-voltage application states. The screen 72a differs from the screen 72 in that the first polarizing plate 75 and the second polarizing plate 77 are disposed in a parallel Nicols state.

In FIG. 11(a), the liquid crystal layer 76 is in a first state that does not change the polarization direction of light. In such a case, vertically-polarized light (a portion of ambient light) that enters the screen 72 from the viewer 8 side passes through the first polarizing plate 75 and the second polarizing plate 77. Similarly, a portion of ambient light (vertically-polarized light) that enters the screen 72a from the side opposite to the viewer 8 passes through the second polarizing plate 77 and the first polarizing plate 75. Thus, in the first state, the screen 72 functions as a transparent screen. In addition, imaging by the camera 6 is turned ON, and it is possible to image the subject via the camera 6.

In FIG. 11(b), the liquid crystal layer 76 is in a second state that changes the polarization direction of light by 90°. In such a case, vertically-polarized light (a portion of ambient light) that enters the screen 72 from the viewer 8 side passes through the first polarizing plate 75, but is converted to horizontally-polarized light by the liquid crystal layer 76 and is blocked by the second polarizing plate 77. Image light (horizontally-polarized light) is blocked by the first polarizing plate 75. Thus, since no light reaches the camera 6, imaging by the camera 6 is turned OFF. In addition, ambient light that enters the screen 72a from the side opposite to the viewer 8 is blocked by the second polarizing plate 77 and the first polarizing plate 75. Thus, in this second state, the screen 72 can obtain a high OD (optical density) value, or in other words, can provide an excellent black display with high contrast.

In the cases shown in FIGS. 10 and 11, the absorption axis of the first polarizing plate 75 can be disposed in a direction different from (orthogonal to) that of the scattering axis of the polarized light scattering layer 3. However, the screen 72a is configured such that the absorption axis partially matches the scattering axis in the region of the first polarizing plate 75 that corresponds to the camera 6 so that image light does not reach the camera 6. Even in such a configuration, it possible to switch between a state that prioritizes contrast and a state that allows for imaging.

### Embodiment 8

Another embodiment of the present invention will be described hereafter. In the present embodiment, a half-wave plate is disposed in place of the liquid crystal of Embodiment 7.

(Configuration of Projection Display Device 81)

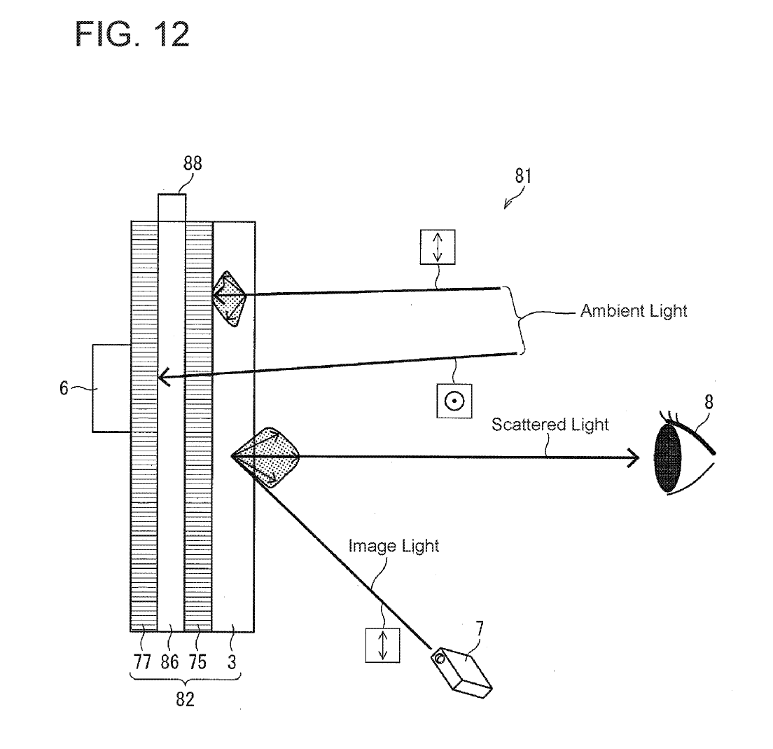

FIG. 12 is a cross-sectional view that shows a schematic configuration of a reflective projection display device 81 according to the present embodiment. The reflective projection display device 81 includes: a screen 82; the camera 6; and the projector 7.

(Screen 82)

The screen 82 includes, stacked in the following order from the viewer 8 side: the polarized light scattering layer 3; the first polarizing plate 75 (polarizing layer); a half-wave plate 86; and the second polarizing plate 77. The half-wave plate 86 is disposed between the two polarizing plates (the first polarizing plate 75 and the second polarizing plate 77). The half-wave plate 86 is rotatably supported with respect to the first polarizing plate 75 and the second polarizing plate 77. In addition, the screen 82 includes a rotating mechanism 88 that rotates the half-wave plate 86 with respect to the first polarizing plate 75 (polarizing layer) and the second polarizing plate 77. The transmission axis of the first polarizing plate 75 matches the vertical direction, and the transmission axis of the second polarizing plate 77 matches the horizontal direction. The first polarizing plate 75 and the second polarizing plate 77 are disposed in a crossed Nicols state. The present embodiment is not limited to this, however, and the polarizing plates may be disposed in a parallel Nicols state.

(Half-Wave Plate 86)

The half-wave plate 86 (a π retardation plate) provides a half-wavelength shift (a retardation of π) to a specified wavelength or the center wavelength (or the wavelength λ2 that corresponds to G) within the wavelength range of ambient light or image light. The fast axis of the half-wave plate 86 is rotatable within an angle range of at least 0° to 45° with respect to the transmission axis of the first polarizing plate 75.

In a first state, the fast axis of the half-wave plate 86 matches the transmission axis of the first polarizing plate 75. In a second state, the fast axis of the half-wave plate 86 is inclined at an angle of 45° with respect to the transmission axis of the first polarizing plate 75. It is possible to switch between the first state and the second state via the rotating mechanism 88.

(Effects)

In the first state, the polarization direction of polarized light that has passed through the first polarizing plate 75 is not changed while passing through the half-wave plate 86. Thus, vertically-polarized light (a portion of ambient light) that passed through the first polarizing plate 75 is blocked by the second polarizing plate 77. A similar process occurs for light that enters the screen 82 from the side opposite to the viewer 8. Thus, in the first state, the screen 82 can obtain a high OD value, or in other words, can provide an excellent black display with high contrast.

Meanwhile, in the second state, the polarization direction of polarized light that has passed through the first polarizing plate 75 is changed by 90° by the half-wave plate 86. Thus, vertically-polarized light that has passed through the first polarizing plate 75 is converted to horizontally-polarized light by the half-wave plate 86 and passes through the second polarizing plate 77. A similar process occurs for light that enters the screen 82 from the side opposite to the viewer 8. Thus, in the second state, the screen 82 functions as a transparent screen. In addition, imaging by the camera 6 is turned ON, and it is possible to image the subject via the camera 6. In either of these two states, image light is blocked by the first polarizing plate 75 and does not reach the camera 6.

In the projection display device 81 of the present embodiment, it is possible to switch, via the rotating mechanism 88, between a first state that prioritizes contrast during the display of image light and a second state that allows for imaging by the camera 6 and allows the screen to function as a transparent screen.

### Embodiment 9

Another embodiment of the present invention will be described hereafter. Hereafter, configurations will be described which combine some of the above-mentioned embodiments.

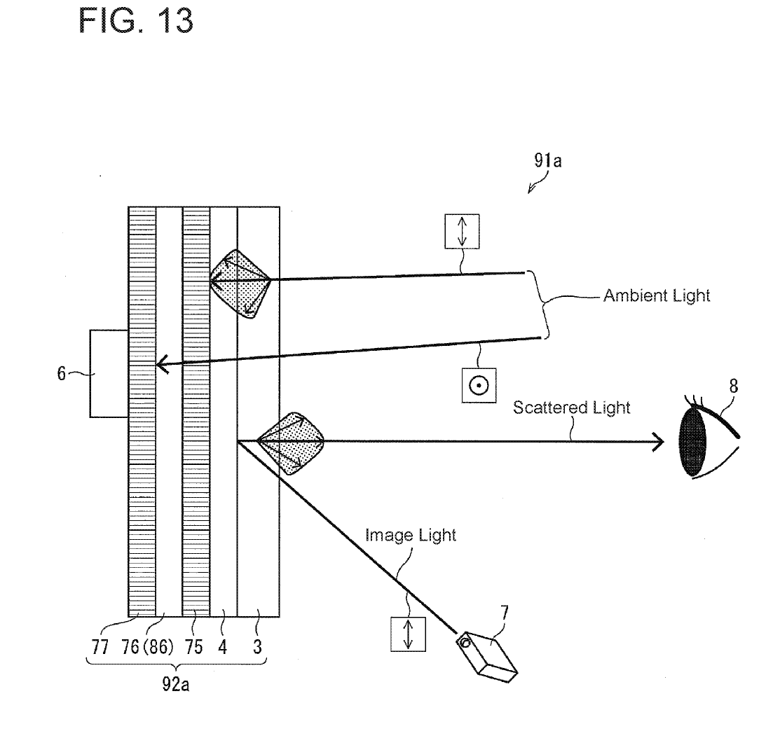

FIG. 13 is a cross-sectional view that shows a schematic configuration of a reflective projection display device 91a according to the present embodiment. The reflective projection display device 91a corresponds to a combination of Embodiments 1 and 7. The projection display device 91a includes: a screen 92a; the camera 6; and the projector 7.

The screen 92a includes, stacked in the following order from the viewer 8 side: the polarized light scattering layer 3; the holographic film 4; the first polarizing plate 75 (polarizing layer); the liquid crystal layer 76; and the second polarizing plate 77. Furthermore, the screen 72 includes a power source (not shown) provided for the liquid crystal layer 76. The liquid crystal layer 76 and the power source may be respectively replaced by the half-wave plate 86 and the rotating mechanism.

In the projection display device 91a, since image light is reflected by the holographic film 4, it is possible to improve light usage efficiency. In addition, it is possible to switch, via driving the liquid crystal layer 76, between a first state that prioritizes contrast during the display of image light and a second state that allows for imaging by the camera 6 and allows the screen to function as a transparent screen.

### Embodiment 10

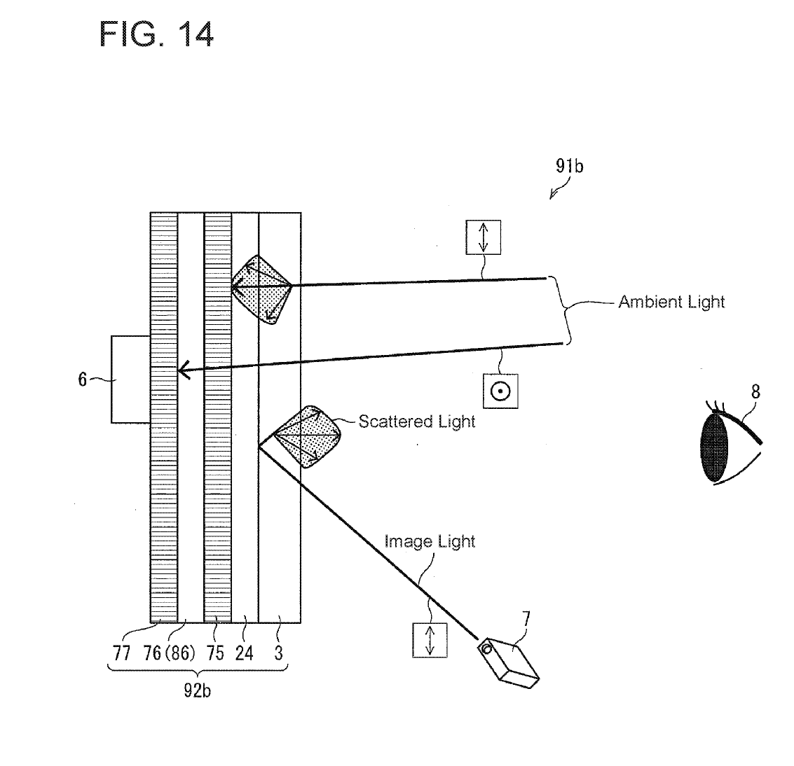

FIG. 14 is a cross-sectional view that shows a schematic configuration of a reflective projection display device 91b according to the present embodiment. The reflective projection display device 91b corresponds to a combination of Embodiments 2 and 7. The projection display device 91b includes: a screen 92b; the camera 6; and the projector 7.

The screen 92b includes, stacked in the following order from the viewer 8 side: the polarized light scattering layer 3; the polarization-selective dielectric mirror 24; the first polarizing plate 75 (polarizing layer); the liquid crystal layer 76; and the second polarizing plate 77. The screen 92b further includes a power source (not shown) provided for the liquid crystal layer 76. The liquid crystal layer 76 and the power source may be respectively replaced by the half-wave plate 86 and the rotating mechanism.

In the projection display device 91b, since image light is reflected by the polarization-selective dielectric mirror 24, it is possible to improve light usage efficiency. In addition, it is possible to switch, via driving the liquid crystal layer 76, between a first state that prioritizes contrast during the display of image light and a second state that allows for imaging by the camera 6 and allows the screen to function as a transparent screen.

### Embodiment 11

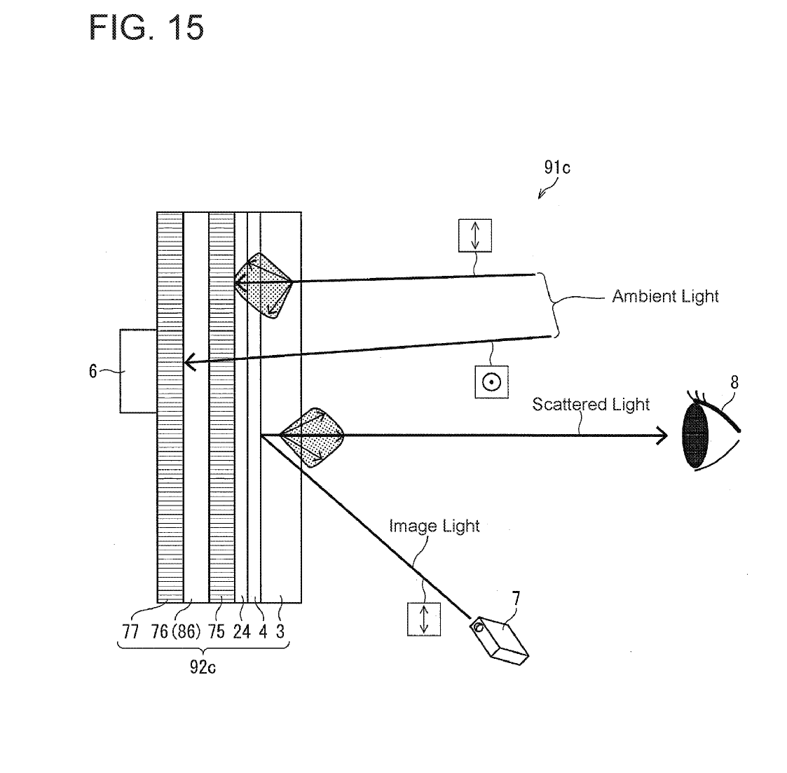

FIG. 15 is a cross-sectional view that shows a schematic configuration of a reflective projection display device 91c according to the present embodiment. The reflective projection display device 91c corresponds to a combination of Embodiments 3 and 7. The projection display device 91c includes: a screen 92c; the camera 6; and the projector 7.

The screen 92c includes, stacked in the following order from the viewer 8 side: the polarized light scattering layer 3; the holographic film 4; the polarization-selective dielectric mirror 24; the first polarizing plate 75 (polarizing layer); the liquid crystal layer 76; and the second polarizing plate 77. The screen 92c further includes a power source (not shown) provided for the liquid crystal layer 76. The liquid crystal layer 76 and the power source may be respectively replaced by the half-wave plate 86 and the rotating mechanism.

In the projection display device 91c, since image light is reflected by the holographic film 4 and the polarization-selective dielectric mirror 24, it is possible to improve light usage efficiency and to widen the viewing angle. In addition, it is possible to switch, via driving the liquid crystal layer 76, between a first state that prioritizes contrast during the display of image light and a second state that allows for imaging by the camera 6 and allows the screen to function as a transparent screen.

### Embodiment 12

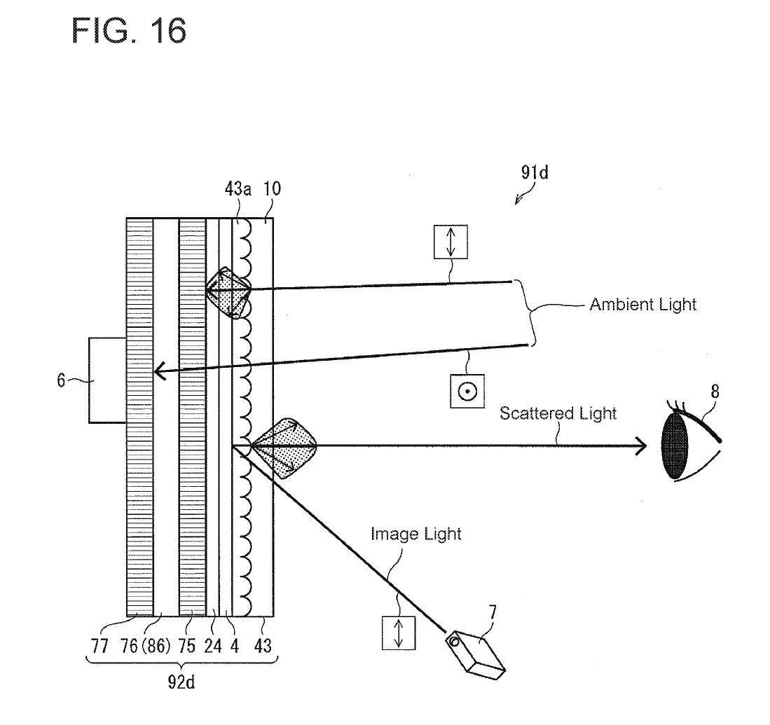

FIG. 16 is a cross-sectional view that shows a schematic configuration of a reflective projection display device 91d according to the present embodiment. The reflective projection display device 91d corresponds to a combination of Embodiments 4 and 7. The projection display device 91d includes: a screen 92d; the camera 6; and the projector 7.

The screen 92d includes, stacked in the following order from the viewer 8 side: the polarized light scattering layer 43; the holographic film 4; the polarization-selective dielectric mirror 24; the first polarizing plate 75 (polarizing layer); the liquid crystal layer 76; and the second polarizing plate 77. The screen 92d further includes a power source (not shown) provided for the liquid crystal layer 76. The liquid crystal layer 76 and the power source may be respectively replaced by the half-wave plate 86 and the rotating mechanism.

In the projection display device 91d, it is possible to more efficiently scatter image light via the lenticular lenses 43a of the polarized light scattering layer 43. In addition, since image light is reflected by the holographic film 4 and the polarization-selective dielectric mirror 24, it is possible to improve light usage efficiency and to widen the viewing angle. In addition, it is possible to switch, via driving the liquid crystal layer 76, between a first state that prioritizes contrast during the display of image light and a second state that allows for imaging by the camera 6 and allows the screen to function as a transparent screen.

### SUMMARY

A screen according to a first configuration of the present invention is a screen that reflects projected image light of a first polarization direction, the screen including: a polarized light scattering layer 3, 43 that scatters polarized light of the first polarization direction; a polarizing layer 5, 75 that blocks polarized light of the first polarization direction and transmits polarized light of a second polarization direction that is orthogonal to the first polarization direction; and a reflective layer 4, 24 that is disposed between the polarized light scattering layer and the polarizing layer, wherein the reflective layer reflects light in accordance with the wavelength or polarization direction thereof so as to selectively reflect image light.

In the above-mentioned configuration, the reflective layer reflects image light that has passed through the polarized light scattering layer back toward the polarized light scattering layer. As a result, the polarized light scattering layer scatters image light that entered from outside the screen and image light that was reflected by the reflective layer. Thus, it is possible to improve the light usage efficiency of image light. Since the light usage efficiency of image light is increased, it is possible for the screen to provide an excellent display and it is possible to reduce the amount of light used by the projection device. In addition, the polarizing layer blocks polarized light (image light) of the first polarization direction that passed through the reflective layer and transmits polarized light of the second polarization direction. Thus, the screen is able to transmit a portion of ambient light.

In a screen according to a second configuration of the present invention, the reflective layer may, in the first configuration, be a reflective hologram 4 that selectively reflects light in accordance with the wavelength thereof.

In the above-mentioned configuration, it is possible to selectively reflect (diffract) wavelengths used in image light via the reflective hologram. Thus, it is possible to decrease the proportion of light other than image light that is reflected toward the polarized light scattering layer. Therefore, it is possible to improve the display quality of images.

In a screen according to a third configuration of the present invention, the reflective layer may, in the first configuration, be a polarization-selective mirror 24 that selectively reflects light in accordance with the polarization direction thereof.

In the above-mentioned configuration, it is possible to selectively reflect polarized image light via the polarization-selective mirror. The polarization-selective mirror reflects polarized light of the first polarization direction and transmits polarized light of the second polarization direction.

In a screen according to a fourth configuration of the present invention, the polarized light scattering layer may, in the first to third configurations, have a configuration that includes lens-shaped bodies that have polarization selectivity in which polarized light of the first polarization direction is refracted to a greater extent that polarized light of the second polarization direction.

A display/imaging device (projection display device) according to a fifth configuration of the present invention may be configured such that: the device includes a screen from the first to fourth configurations mentioned above, and an imaging device (a camera 6) provided on the polarizing layer side of the screen so as to be adjacent to the screen; the screen includes a light absorption layer that is on the imaging device side of the reflective layer; and the light absorption layer is disposed in a region in which the imaging device is not disposed.

In such a configuration, since it is possible for ambient light to be absorbed by the light absorption layer, it is possible to provide an excellent black display with high contrast. In addition, it is possible to reduce the visibility of the imaging device with respect to the viewer. In addition, since the imaging device is adjacent to the screen, it is possible to decrease the effect of light scattering on imaging even when light of the second polarization direction is scattered to a small degree by the polarized light scattering layer.

A display/imaging device according to a sixth configuration of the present invention may be configured such that: the device includes a screen from the first to fourth configurations mentioned above, and an imaging device provided on the polarizing layer side of the screen; and the screen includes a quarter-wave plate that is on the imaging device side of the polarizing layer.

In such a configuration, the polarization state of light is converted by the quarter-wave plate such that light reflected by the imaging device does not pass through the polarizing layer. Thus, it is possible to prevent light reflected by the imaging device from being seen by the viewer.

In a display/imaging device according to a seventh configuration of the present invention, the casing of the imaging device may be, in the sixth configuration, made of a material that maintains the polarization state of light during reflection.

A screen according to an eighth configuration of the present invention may be configured such that, in the first to fourth configurations: the screen includes the above-mentioned polarizing layer as a first polarizing layer, a second polarizing layer disposed on the viewer side of the first polarizing layer, and a polarization conversion layer disposed between the first polarizing layer and the second polarizing layer; and the polarization conversion layer is able to switch between a first state that does not change the polarization direction of polarized light passing therethrough, and a second state that changes the polarization direction of polarized light passing therethrough.

In such a configuration, if the polarization direction of polarized light that has passed through the first polarizing layer is changed by the polarization conversion layer to a polarization direction that will not pass through the second polarizing layer, the screen is in a state that does not transmit ambient light. Thus, the screen can provide an excellent black display with high contrast. Meanwhile, if the polarization direction of polarized light that has passed through the first polarizing layer is changed by the polarization conversion layer to a polarization direction that will pass through the second polarizing layer, then the screen is in a state that transmits a portion of ambient light. Thus, the screen can be used as a transparent screen.

In a screen according to a ninth configuration of the present invention, the polarization conversion layer may, in the eighth configuration, be a liquid crystal layer or a half-wave plate.

A display/imaging device according to a tenth configuration of the present invention may be configured so as to include: a screen from the first to fourth, eighth, and ninth configurations; an imaging device provided on the polarizing layer side of the screen; and a projection device that projects onto the screen polarized image light of the first polarization direction.

A display/imaging device according to an eleventh configuration of the present invention may be configured such that, in the fifth to seventh and tenth configurations, the projection device utilizes a laser light source as the light source.

The present invention is not limited to the embodiments described above, and various modifications can be made without departing from the scope of the claims. Therefore, embodiments obtained by appropriately combining the techniques disclosed in different embodiments are included in the technical scope of the present invention. Moreover, new technical features can be created by combining the technical configurations described in the respective embodiments.

### INDUSTRIAL APPLICABILITY

The present invention can be used in a screen and a display/imaging device.

### DESCRIPTION OF REFERENCE CHARACTERS

1, 21, 31, 41, 51, 61, 71, 81, 91a to 91d projection display device (display/imaging device)
2, 22, 32, 42, 52, 62, 72, 72a, 82, 92a to 92d screen
3, 43 polarized light scattering layer
4 holographic film (reflective hologram)
5 polarizing layer
6 camera (imaging device)
7 projector (projection device)
8 viewer
9 adhesive
10 base material
11 scattering microparticle
24 polarization-selective dielectric mirror (polarization-selective mirror)
43a lenticular lens (lens-shaped body)
56 light absorption layer
66 quarter-wave plate
75 first polarizing plate (first polarizing layer)
76 liquid crystal layer
77 second polarizing plate (second polarizing layer)
78 power source
86 half-wave plate
88 rotating mechanism

1. A screen for reflecting projected image light of a first polarization direction, the screen comprising:
a polarized light scattering layer that scatters polarized light of the first polarization direction;
a polarizing layer that blocks polarized light of the first polarization direction and transmits polarized light of a second polarization direction that is orthogonal to the first polarization direction; and
a reflective layer disposed between the polarized light scattering layer and the polarizing layer,
wherein the reflective layer reflects light according to wavelength and/or polarization direction so as to selectively reflect said image light.

2. The screen according to claim 1, wherein the reflective layer is a reflective hologram that selectively reflects light according to wavelength.

3. The screen according to claim 1, wherein the reflective layer is a polarization-selective mirror that selectively reflects light according to polarization direction.

4. A display imaging device, comprising:
the screen according to claim 1; and
an imaging device provided on a side of the screen adjacent to the polarizing layer,
wherein the screen includes a light absorption layer closer to the imaging device than the reflective layer, and
wherein the light absorption layer is disposed in a region where the imaging device is not disposed.

5. A display imaging device, comprising:
the screen according to claim 1; and
an imaging device provided on a side of the polarizing layer adjacent to the screen,
wherein the screen includes a quarter-wave plate closer to the imaging device than the polarizing layer.

6. The screen according to claim 1, wherein the reflective layer comprises a reflective hologram that selectively reflects light according to wavelength and a polarization-selective mirror that selectively reflects light according to polarization direction, the reflective hologram and the polarization-selective mirror being laminated together.

7. The screen according to claim 1, wherein the polarizing layer comprises a first polarizing plate, a second polarizing plate, and a liquid crystal layer interposed therebetween.

8. The screen according to claim 1, wherein the polarizing layer comprises a first polarizing plate, a second polarizing plate, and a half-wave plate interposed therebetween.
